(19) United States
(12) Patent Application Publication
(10) Pub. No.: US 2015/0014498 A1
(43) Pub. Date: Jan. 15, 2015

(54) Air Spring Fastening

(71) Applicant: SAF-HOLLAND GmbH, Bessenbach (DE)

(72) Inventor: Helmut Hock, Bessenbach (DE)

(21) Appl. No.: 14/370,896

(22) PCT Filed: Jan. 23, 2013
(86) PCT No.: PCT/EP2013/051191

§ 371 Date: Jul. 7, 2014

(30) Foreign Application Priority Data
Feb. 7, 2012 (DE) 102012201745.3

(51) Int. Cl. B60G 11/28

(52) U.S. Cl. CPC B60G 11/28; B60G 2202/15; B60G 2204/126
USPC 248/205.1

(57) ABSTRACT

An air spring fastening including a positioning element, a radius arm unit, and an air spring unit, wherein the radius arm unit and the air spring unit each having a fastening section, the positioning element having a first engagement section that can be brought into engagement with a first fastening section to secure the positioning element against displacement in a positioning plane the positioning element having at least one second engagement section running transversely to the positioning plane and arranged eccentrically to the positioning plane on the positioning element, and wherein a second fastening section can be fixed transversely to the positioning plane in alignment with the second engagement section by at least one engagement arrangement to fix the second fastening section in a certain installation position by fixing the positioning element in a certain rotation position.

### BACKGROUND OF THE INVENTION

The present invention relates to an air spring fastening, in particular for use in commercial vehicles or utility vehicles.

It is well known to fasten an air spring or an air-suspension bellows between the vehicle frame of a commercial vehicle and a radius arm, which is arranged displaceably relative to said vehicle frame. Here, a first section of the air spring may be fixed to the vehicle frame of the commercial vehicle, and a second section of the air spring, which is displaceable relative to the first section, is fastened to the radius arm unit, such as by means of a screw/bolt. In case various air springs are to be used on a frame having a certain geometric configuration, there are problems when it comes to exactly positioning the air spring on the frame and on the radius arm unit. Consequently, in case various air springs are to be used on one and the same commercial vehicle, both the radius arm unit and the interface on the frame have to be specifically designed, which tremendously increases the manufacturing outlay.

The object underlying the present invention is to provide an air spring fastening, by means of which the air spring may be positioned relative to the radius arm unit and/or the frame of the commercial vehicle so as to be able to fix various air springs to one and the same radius arm unit or the frame of a commercial vehicle.

### SUMMARY OF THE INVENTION

According to the invention, the air spring fastening comprises a positioning element, a radius arm unit, and an air spring unit, wherein the radius arm unit and the air spring unit each have a fastening section, wherein the positioning element has a first engagement section that can be brought into engagement with a first fastening section in order to secure the positioning element against displacement in a positioning plane relative to the first fastening section, wherein the positioning element has at least one second engagement section that runs or extends transversely to the positioning plane and further is arranged eccentrically in relation to the positioning plane on the positioning element, wherein a second fastening section can be fixed transversely to the positioning plane in alignment with the second engagement section by means of at least one engagement or fastening means in order to fix the second fastening section in a certain installation position in relation to the first fastening section by fixing the positioning element in a certain rotation position relative to the first fastening section. Preferably, the positioning element is a plate-shaped body, which extends essentially along a positioning plane in its installation position, i.e. in the position, in which it connects the radius arm unit and the air spring. The positioning element has a first engagement section, preferably at its edges, i.e. at the limiting surfaces with the least extension or with an extension transverse to the positioning plane. Particularly preferably, the radius arm unit is the radius arm or trailing arm of a commercial vehicle. Usually, such radius arm is fixed to the vehicle frame rotatably about a first end, and at a second end comprises an engagement section, to which an air spring unit may be fixed indirectly or directly. Particularly preferably, the radius arm unit in the area of the engagement section is configured flat or rolled out or essentially plate-shaped. Particularly preferably, the radius arm unit comprises a fastening flange, which is plate-shaped, for example, and which at a first side is fixed to the radius arm and/or the axle of the commercial vehicle by means of fastening means, and at the second side of which the air spring unit is supported and fixed. The air spring unit is particularly preferably the air spring of a commercial vehicle, wherein it comprises at least two assemblies, which are movable relative to each other, particularly preferably a plunger piston and a cover plate, between which there is arranged an elastically deformable air bellows, which is filled by compressed air. In the sense of the present invention, reference is made in particular to the plunger piston or the cover plate of the air spring unit, since by means of a positioning element according to the invention one of said two components may be fixed to the radius arm unit and the respective other one may be fixed to the frame of the commercial vehicle. According to the invention, there is provided a first fastening section, which may be made to engage the first engagement section, i.e. preferably the outer geometry of the positioning element, and which positively or form-fittingly secures the positioning element at least against displacement in the positioning plane and against rotation relative to the first fastening section. Here, the first fastening section may be provided either on the radius arm or on the air spring unit, wherein the respective other assembly, i.e. the air spring unit or the radius arm unit, comprises a second fastening section. The second fastening section is particularly preferably adapted to indirectly or directly engage a second engagement section on the positioning element. According to the invention, the second engagement section of the positioning element extends transversely to the positioning plane and is arranged on the positioning element eccentrically relative to the centroid of the extension of the positioning element in the positioning plane. The eccentric arrangement may also mean that the second engagement section is arranged outside of the center of an imaginary inner or outer circle of the extension of the positioning element in the positioning plane. In order to fix the air spring unit in a certain position relative to the radius arm unit, the second fastening section, which is firmly connected to one of the two units, is brought into a position or location, where it may directly, i.e. immediately, come into engagement with the second engagement section or is fixed by means of an additionally provided engagement means relative to the second engagement section. In particular, the main extension direction of the second fastening section is oriented transversely to the positioning plane in a position aligned or coaxial relative to the second engagement section of the positioning element. Due to the eccentric arrangement of the second engagement section on the positioning element, it is possible to change or adjust the location of the second engagement section relative to the first fastening section by setting a certain rotation position of the positioning element in the positioning plane. Expediently, the first fastening section is a cavity provided on the radius arm unit, and the second fastening section is preferably a recess or a projection provided on the air spring unit, wherein in the latter case the first engagement section of the positioning element may be connected form-fittingly or positively to the radius arm, and the second engagement section of the positioning element comes into engagement, in particular a form-fitting engagement, with the air spring unit. Alternatively and equally preferably, the first fastening section may also be provided on the air spring unit, and the second fastening section may be a cavity or a projection on the radius arm unit. Preferably, the geometries of the first engagement section and of the first fastening section are designed such that they largely correspond to each other, i.e. that, apart from manufacturing tolerances, they may be placed essentially one on top of the other.

Preferably, the first engagement section of the positioning element is arranged in that portion of the positioning element, which has a larger extension along or parallel to the positioning plane than the portion, in which the second engagement section is arranged. Thus, thanks to a torque, which is sufficiently high at low forces, it is possible to secure the positioning element against rotation in the positioning plane relative to the first fastening section. Further preferably, the first engagement section directly, i.e. without any further additional elements, engages the first fastening section. Preferably, this reduces the mounting work for the air spring fastening since fewer components are required in order to fix the air spring unit to the radius arm unit.

In a preferred embodiment, the second engagement section is arranged spaced apart by a distance from the centroid of the extension of the positioning element in the positioning plane. To put it differently, the extension of the positioning element is preferably the surface of the positioning element parallel to or along the positioning plane, and the centroid of said surface or of said extension is particularly preferably the center of an imaginary inner circle of said surface. Said distance between the second engagement section and the centroid of the extension of the positioning element also defines the possible adjustment space or the maximum possible distance between the possible installation positions of the radius arm unit relative to the air spring unit. The maximum distance between two installation positions or the maximum offset between two installation positions is double the distance of the second engagement section from the centroid.

Preferably, the positioning element has a plurality of second engagement sections, wherein the distances between the respective engagement sections preferably differ. In order to allow for a plurality of possible installation positions of the air spring unit relative to the radius arm unit already without rotating the positioning element, preferably a plurality of second engagement sections is provided. In order to fix the radius arm unit to the air spring unit, preferably only one of the respective second engagement sections is used. In a first preferred embodiment, the second engagement sections may have the same distance A from the respective centroid of the positioning element. Alternatively preferably, the engagement sections have different distances from the centroid, wherein in combination with a plurality of selectable installation positions of the positioning element relative to the first fastening section, an even larger number of installation positions of the air spring unit relative to the radius arm unit is made possible. If, for example, the positioning element comprises three second engagement sections, the air spring may be arranged in three different installation positions relative to the radius arm unit. If said positioning element may be arranged in three further rotation positions in the positioning plane relative to the first fastening section, the number of possible installation positions of the air spring unit relative to the radius arm unit increases to twelve.

Further preferably, there is arranged a second engagement section at an angle a from an adjacent second engagement section, wherein the respective angle a is preferably larger than 0° and smaller than 180°. By arranging the second engagement sections about the centroid of the positioning element with an angular offset a, preferably as many as possible second engagement sections may be provided on a relatively small surface of the positioning element. Here, it is above all preferably possible to provide second engagement sections with a relatively large cross-section in the positioning plane on the positioning element.

Preferably, the absolute value of the deviation of a respective angle α₁ . . . αₙ from the value of the relationship of 360° to the number of second engagement sections is between 0° and 90°, preferably between 0° and 30°, and particularly preferably between 0° and 10°. Expediently, the second engagement sections are distributed as evenly as is possible over the positioning element, wherein in order to achieve said even distribution the second engagement sections are arranged with the same angles inbetween. If, for example, there are provided four second engagement sections, the value of the relationship of 360° to the number of second engagement sections is 90°, which in turn corresponds to the mean value of the angles between the engagement sections and the centroid. In case the respective individual second engagement sections are arranged offset to each other by 90° relative to the centroid, the deviation or the absolute value of the deviation of each angle α₁ to α₄ is 0°. If in another example three of the angles are small, such as between 10° and 40°, and a fourth angle α₄ is accordingly large, there is a high value of deviation of the respective angle from said mean value. In addition, an even distribution of the second engagement sections is particularly preferred for an even distribution of forces along the positioning element, when the force is initiated via the fastening element, via the first fastening section and the second fastening section.

In a preferred embodiment, the first engagement section has a polygonal extension in the positioning plane, wherein the first fastening section has a polygonal extension in the positioning plane, which corresponds thereto at least over a certain area. The first engagement section or the outer geometry of the positioning element is particularly preferably polygonal, i.e. the positioning element preferably has an angular or cornered cross-sectional geometry, such as a rectangular cross-sectional geometry, when seen perpendicular to the positioning plane. On the one hand, this offers the advantage that the positioning element and the first engagement section may be easily manufactured, such as by plate cutting, level filing or grinding. On the other hand, a polygonal extension of the first engagement section during the at least partial form-lock of the first engagement section in the first fastening section makes it possible to secure the positioning element against rotation relative to the first fastening section. In the case of a rectangular positioning element, the positioning element is preferably installed in a first position, a position rotated by 180° in the positioning plane, and in two further positions, in which the positioning element is turned transversely to the positioning plane, i.e. in other words turned upside down, again in two installation positions arranged at 180° relative to one another.

Particularly preferably, the first engagement section has an equilateral polygonal extension in the positioning plane. Thus, it is possible to select as many rotation positions in the positioning plane as there are corners on the polygonal cross-section or the polygonal extension of the first engagement section. For example, it is possible to arrange a square cross-section in a first installation position, defined as 0°, and in three further installation positions rotated 90°, 180° and 270° in the positioning plane, relative to the first fastening section, which, depending on the number of second engagement sections on the positioning element, results in a plurality of possible installation positions of the air spring relative to the radius arm unit. Particularly preferably, the first engagement section may be provided with eight or twelve corners, for example, to allow for the possibility of fine-adjustment when the installation position of the air spring relative to the radius arm is set, in particular in combination with a small distance of the second engagement section from the respective centroid. Particularly preferably, on the plunger piston and the cap of the air spring, a fastening is provided indirectly or directly by means of positioning elements according to the invention, wherein in this way for example an offset of the fastening section on the frame of the commercial vehicle relative to the fastening section on the radius arm unit of the commercial vehicle may be compensated. The air spring may thus preferably be installed and adjusted in a position, which is suitable and advantageous for the load to be expected.

In an alternatively preferred embodiment, the first engagement section extends essentially circularly in the positioning plane and has at least one projection along the positioning plane, which may be made to engage a corresponding recess on the first fastening section extending essentially circularly in the positioning plane. The projection on the first engagement section may preferably be designed as a rectangular, triangular or rounded nose, wherein said projection may be made to engage an essentially corresponding recess on the first engagement section. Apart from the projection, the outer geometry of the first engagement section and, thus, the outer geometry of the positioning element, may be essentially circular. Corresponding to the first engagement section, the first fastening section has an essentially circular geometry with a recess, wherein, when the first engagement section and the first fastening section engage, the first engagement section is form-locked and secured against displacement and rotation in the positioning plane relative to the first fastening section. It may be particularly preferred that the first fastening section comprises a plurality of recesses, which may be made to engage one respective projection of the first engagement section. Thus, a plurality of possible rotation positions of the engagement section relative to the first fastening section may be adjusted.

In a particularly preferred embodiment, the second engagement section is a cavity, which is engaged by the second fastening section or by an engagement means. Particularly preferably, the second engagement section provided on the positioning element is designed as a bore. Said cavity or bore may be engaged by a second fastening section or by an engagement means, which is designed as a projection, wherein in the first embodiment, the second fastening section is directly fixed to the second engagement section and, in the second embodiment, the second fastening section is fixed to the second engagement section only indirectly via the engagement means. Particularly preferably, the second engagement section may have an internal thread, which is engaged by an engagement means so as to fix the positioning element relative to the radius arm unit and the air spring unit.

Preferably, the positioning element may be fixed to the first fastening section in a rotated installation position both in the positioning plane and transverse to the positioning plane. A rotation or displacement in the positioning plane may take place in particular also in a plane parallel to the positioning plane. To put it differently, this means that the installation position of the positioning element relative to the first fastening section may be adjusted both by rotating it in the positioning plane and by rotating or pivoting it transversely to the positioning plane, preferably by 180°. As has been described above, it is thus possible to increase the number of possible installation positions of the radius arm unit relative to the air spring unit.

It may be particularly preferred to design the second engagement section as a threaded pin forming an integral part of the positioning element. Since it is intended to reduce the number of components to be mounted, it is preferred to design the second engagement section as a threaded pin, which already during the casting process or after having been welded to the positioning element, is connected to the positioning element by a substance-to-substance bond. After the threaded pin has been inserted into the second fastening section, only a nut has to be screwed onto the threaded pin so as to fix the positioning element at the respective opposite element.

In a particularly preferred embodiment, the first fastening section is a cavity transverse to the positioning plane on the air spring unit, wherein the second fastening section is provided on the radius arm. It is in particular preferred to provide a respective cavity at the bottom of the plunger piston of an air spring or at the cap of an air spring, for example, which cavity is positively engaged by the positioning element. In this preferred embodiment, there is provided on the radius arm unit a respective second fastening section, which preferably may be designed as a projection, such as a threaded rod, or as a recess, i.e. as a bore or cavity, for example. Alternatively, the first fastening section may also be provided on the radius arm, wherein the second fastening section accordingly has to be provided on one of the components of the air spring unit, which are immobile relative to the air spring unit.

In a further preferred embodiment, the first fastening section comprises a retention collar, against which the positioning element may be pushed or pressed or urged via the fastening means, so as to frictionally or force-fittingly fix the air spring unit to the radius arm. In particular in order to enhance the positive connection of the air spring unit via the positioning element and the two fastening sections or the two engagement sections to the radius arm by means of a friction lock, it may be preferred to provide a retention collar on the first fastening section, against which the positioning element may be pushed with its first engagement section so as to thus push the air spring unit against the radius arm unit.

Further advantages and features of the present invention become apparent from the following description of preferred embodiments with reference to the appended Figures. As a matter of course, individual features of the various embodiments may be combined within the framework of the invention.

### BRIEF DESCRIPTION OF THE DRAWINGS

The Figures show:

FIG. 1 shows a first sectional view of a preferred embodiment of the air spring fastening according to the invention;

FIG. 2 shows a sectional view of a second preferred embodiment of the air spring fastening according to the invention;

FIG. 3 shows a view of the positioning element according to the invention;

FIGS. 4a)-c) show views of various embodiments of the positioning element, in particular of the first engagement section 21.

### DETAILED DESCRIPTION OF THE PREFERRED EMBODIMENTS

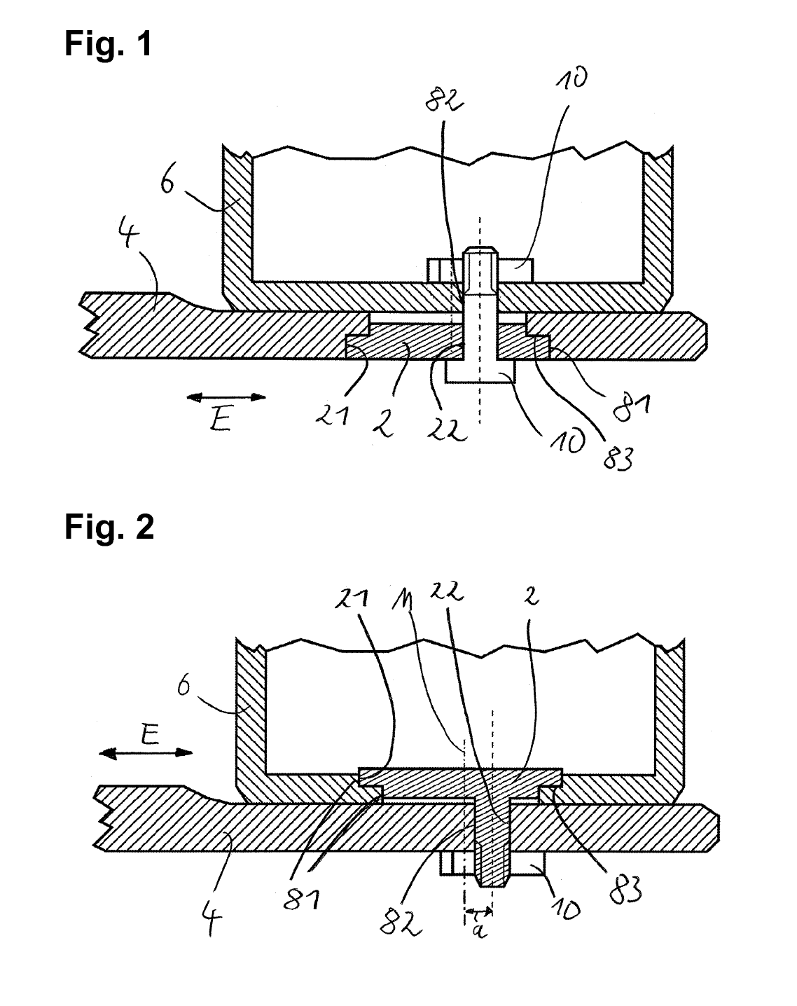

In the embodiment of the air spring fastening of the invention shown in FIG. 1, an air spring unit 6 is put onto a radius arm unit 4 and fixed to the radius arm unit 4 by means of a positioning element 2 and a fastening means 10. The air spring unit 6 is preferably the plunger piston of an air spring of a commercial vehicle. In the bottom of the plunger piston or in the surface thereof standing essentially parallel to the positioning plane E, there is provided a second fastening section 82, which is designed as a cavity or bore. The radius arm unit 4 comprises a cavity, which is essentially transverse to the positioning plane E, namely the first fastening section 81, which is at least partially positively engaged by a first engagement section 21 of the positioning element 2. The first fastening section 81 further has a retention collar 83, on which the first engagement section 21 of the positioning element 2 rests against displacement transverse to the positioning plane E. The first engagement section 21, different from what is shown in the Figure, may also have a step-less outer geometry, wherein the positioning element 2 both with its upper side and with its lower side may be put or placed onto the retention collar 83. The positioning element 2 further comprises a second engagement section 22, wherein the second fastening section 82 of the air spring unit 6 is directed essentially in alignment with or coaxial to said second engagement section. In the second fastening section 82 and the second engagement section 22, there is inserted a fastening means 10, which preferably is designed as a screw/bolt or a pin with an undercut and engages a second fastening means 10, such as a nut, in order to push the air spring unit 6 against the radius arm unit 4. Here, it is preferred that the thickness of the positioning element 2, shown above the collar 83 in the Figure, transverse to the positioning plane E is less than the thickness of the radius arm unit 4 in this area, in order to make it possible to pretension the air spring unit 6 against the radius arm unit 4 indirectly via the positioning element 2 and the fastening means 10.

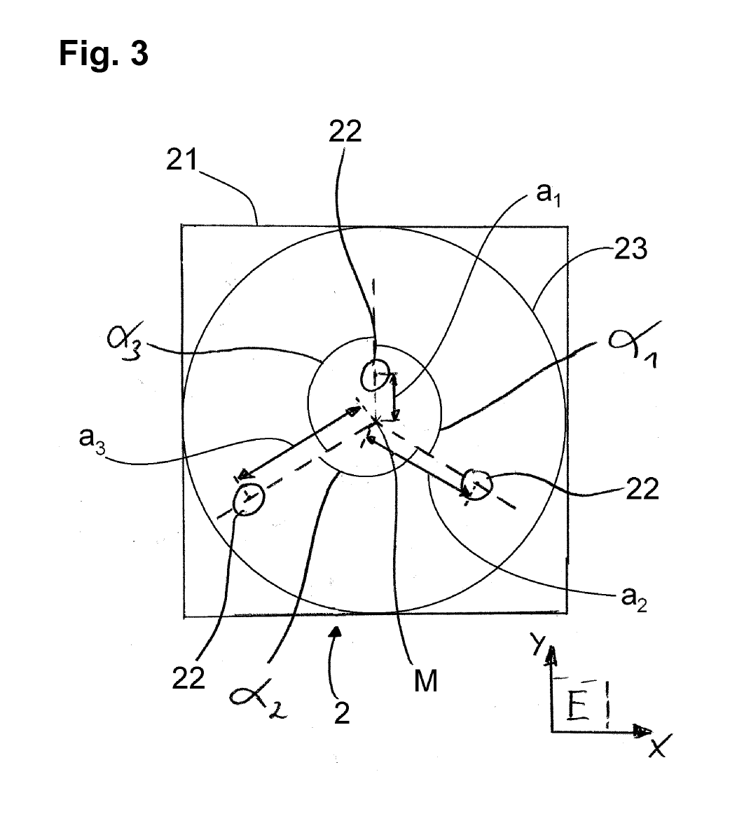

FIG. 2 shows an alternative embodiment of the air spring fastening of the invention, wherein the first fastening section 81 is provided on the air spring unit 6 and wherein the second fastening section 82 is preferably provided on the radius arm unit 4. Here, the positioning element 2 may be inserted preferably from above into the plunger piston of the air spring unit 6, wherein the first engagement section 21 thereof comes into positive engagement with the first fastening section 81 provided on the air spring unit 6. The second engagement section 22 provided on the positioning element 2 is preferably designed as a threaded pin, which is arranged at a distance a from the centroid M of the extension of the positioning element 2 lying parallel to the positioning plane E, and particularly preferably forms an integral part of the positioning element 2 so as to come into positive and frictional engagement with a second fastening means 10 and to thus fix the air spring unit 6 to the radius arm unit 4 via the positioning element 2. As a matter of course, said one-piece design of the threaded pin and the positioning element 2 may also be used in the arrangement of the first and second fastening sections 81, 82 shown in FIG. 1. Likewise, for the arrangement of the first and second fastening sections 81, 82 shown in FIG. 2, a separate fastening means 10 designed as screw/bolt or pin may be used.

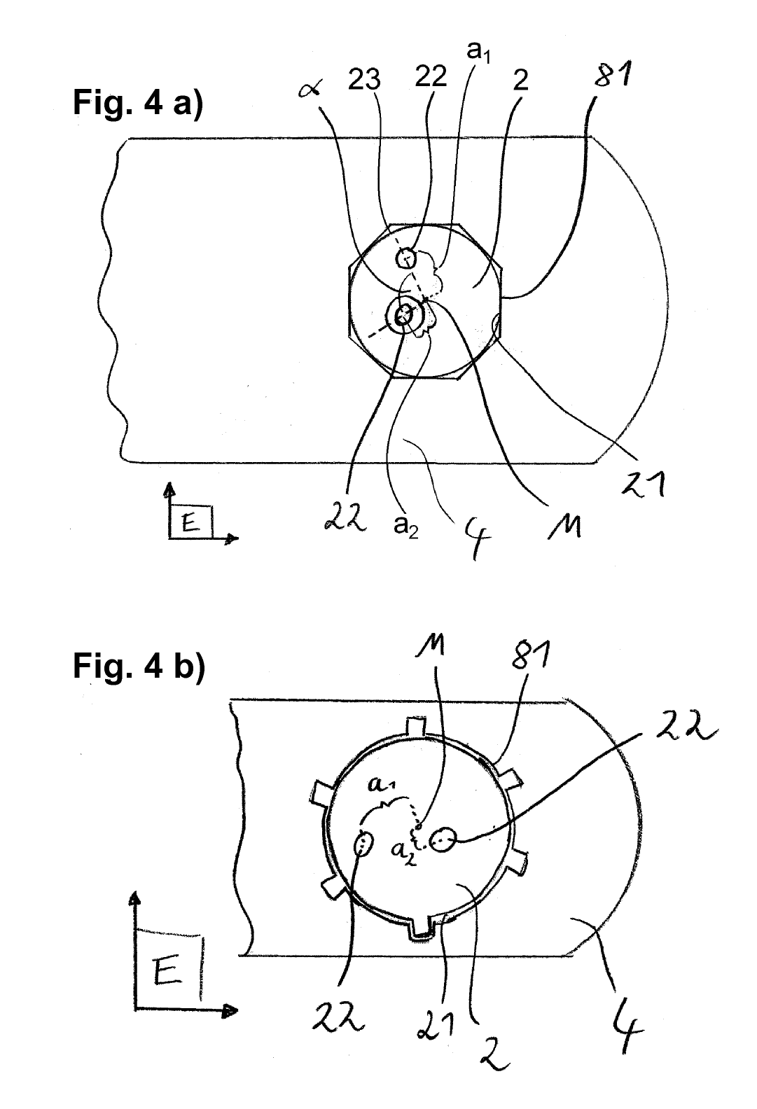

FIG. 3 shows a preferably square-formed embodiment of the first engagement section 21 of the positioning element 2, wherein three second engagement sections 22 are provided on the positioning element, which are arranged at respective different distances α₁ . . . α₃ from the center M of the inner circle 23 of the square or from the centroid of the intersection of the positioning element 2 in the positioning plane E. Furthermore, the three second engagement sections shown are each spaced apart by a respective angle α, in relation to the centroid M. As will be easily understood, the positioning element 2 may be arranged and fixed in four possible installation or rotation positions relative to the respective corresponding first fastening section 81, resulting in a total of twelve possible fastening positions of the air spring unit on the radius arm unit 4 in the three preferred second engagement sections 22 shown. Said respective number may be doubled by turning the positioning element 2 also transverse to the positioning plane E, i.e. by turning its bottom side upwards. In order to exactly determine the individual fastening positions or the coordinates of the individual second engagement sections 22, it is helpful to define a coordinate system, which is stationarily provided on the first fastening section 81, wherein the latter in turn may be arranged both on the radius arm unit 4 and on the air spring unit 6. For each of the possible rotation positions of the positioning element 2 for each of the second engagement sections 22 certain coordinate pairs (x, y) result. Due to the large number of possible installation positions, it is advisable to provide respective markings and labels on the positioning element 2, so that when the air spring unit 6 is mounted on a radius arm unit 4 both the correct rotation position of the positioning element 2 relative to the first fastening section 81 and the use of the correct second engagement section 22 is easily discernible for the technician.

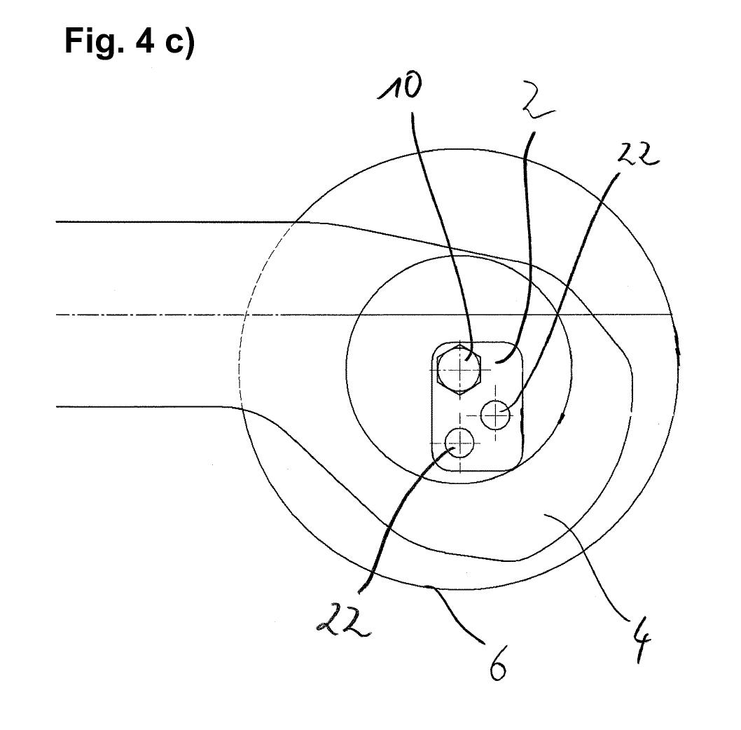

FIGS. 4a)-c) show three different embodiments of the positioning element, in particular of the first engagement section 21 of the positioning element 2. FIG. 4a) shows an octagonal cross-section of the first engagement section 21, which corresponds to a preferably also octagonal geometry of the first fastening section 81. Furthermore, there is shown that the first fastening section 81 is provided on the radius arm unit 4. It is characteristic that the engagement section 21 has an equilateral polygonal cross-sectional geometry. Preferably, the first engagement section 21 and the essentially corresponding first fastening section 81 may be formed equilaterally triangular, pentagonal or hexagonal or heptagonal. A larger number of corners is possible, wherein, however, in the case of too many corners or too short edges and too small a deviation from a circle, the first engagement section 21 is no longer sufficiently secured against rotation relative to the first fastening section 81. A large number of corners and a good protection against rotation may be achieved by means of a star-shaped cross-sectional geometry of the first engagement section 21, for example. The number of corners in the case of an equilateral design equals the number of possible rotation positions of the first engagement section 21 relative to the first fastening section 81 in the positioning plane E. The positioning element 2 has two second engagement sections 22, wherein said engagement sections are located at different distances α₁, α₂ from the centroid M, which in the present case is identical to the center of the inner circle 23 of the octagon, and which are arranged at an angle a relative to each other. The second engagement sections 22 in addition have different diameters, which in particular serves for accommodating differently sized engagement means 10 so as to be able to fix to the radius arm unit 4 differently sized air spring units 6 with differently sized second fastening sections 82.

FIG. 4b) shows a preferred embodiment, in which the first engagement section 21 is essentially circular and has a projection at its outside only. The first fastening section 81, which largely corresponds to the first engagement section 21, is also essentially circular and comprises a plurality of recesses distributed along the circumference, wherein the projection on the first engagement section 21 engages one of said recesses. In the example shown, the positioning element 2 may be arranged in six rotation positions relative to the radius arm unit 4 or relative to the first fastening section 81, wherein in the two second engagement sections 22 shown a total of twelve possible installation positions of an air spring relative to the radius arm 4 result. Advantageously, the first engagement section 21 may have a plurality of projections, wherein said projections advantageously are evenly distributed along the circumference of the first engagement section 21 and engage recesses, which are also evenly distributed over the first fastening section 81. It is also a matter of course that the first engagement section 21 preferably also may have recesses, which are engaged by corresponding projections of the first fastening section 81. FIG. 4c) shows a preferably rectangular embodiment of the first engagement section 21 of the positioning element 2, wherein there are preferably provided three second engagement sections 22. An engagement means 10 engages the uppermost of the three engagement sections 22 so as to fix the air spring unit 6 to the radius arm unit 4.

Insofar as there are provided at least two second engagement means 22 on the positioning element 2, preferably a first engagement section 22 may be arranged centeredly on the positioning element and all further second engagement sections may be arranged eccentrically on the positioning element 4, as has been described above.

### LIST OF REFERENCE SIGNS

2—positioning element
4—radius arm unit
6—air spring unit
10—fastening means
21—first engagement section
22—second engagement section
23—inner circle
81 —first fastening section
82 —second fastening section
83—retention collar
E—positioning plane
M—centroid
a_{1 . . . n}—distance from centroid
α_{1 . . . n}—angle
x, y—coordinates

1-12. (canceled)

13. An air spring fastening for commercial vehicles, comprising:
a positioning element, a radius arm unit, and an air spring unit;
wherein the radius arm unit and the air spring unit each have a fastening section;
wherein the positioning element has a first engagement section that can be brought into engagement with a first fastening section to secure the positioning element against displacement in a positioning plane relative to the first fastening section;
wherein the positioning element has at least one second engagement section that extends transversely to the positioning plane and is arranged eccentrically in relation to the positioning plane on the positioning element;
wherein a second fastening section can be fixed transversely to the positioning plane in alignment with the second engagement section by at least one fastening arrangement to fix the second fastening section in a certain installation position in relation to the first fastening section by fixing the positioning element in a certain rotation position relative to the first fastening section; and
wherein the second engagement section is arranged spaced apart by a distance from an imaginary centroid of the extension of the positioning element in the positioning plane.

14. The air spring fastening of claim 13, wherein the first engagement section of the positioning element is arranged in a first portion of the positioning element that has a larger extension along the positioning plane than a second portion in which the second engagement section is arranged.

15. The air spring fastening of claim 14, wherein the positioning element comprises a plurality of second engagement sections, and wherein the distances (a) of at least some of the plurality of second the engagement sections differ from each other.

16. The air spring fastening of claim 15, wherein a pair of adjacent second engagement sections of the plurality of second engagement sections are arranged displaced by an angle (α) relative to one another, and wherein the angle (α) is greater than 0° and less than 180°.

17. The air spring fastening of claim 16, wherein an absolute value of a deviation of a respective angle α₁ . . . αₙ from a value of the relationship of 360° to a number of second engagement sections is between about 0° and about 90.

18. The air spring fastening of claim 17, wherein the absolute value of the deviation of the respective angle α₁ . . . αₙ from the value of the relationship of 360° to the number of second engagement sections is between 0° and 30°.

19. The air spring fastening of claim 18, wherein the absolute value of the deviation of the respective angle α₁ . . . αₙ from the value of the relationship of 360° to the number of second engagement sections is between 0° and 10°.

20. The air spring fastening of claim 17, wherein the first engagement section has a polygonal extension in the positioning plane, and wherein the first fastening section has a polygonal extension in the positioning plane, which corresponds to the polygonal extension of the first engagement section at least over a certain area.

21. The air spring fastening of claim 17, wherein the first engagement section extends essentially circularly in the positioning plane and comprises at least one projection along the positioning plane engageable with a corresponding recess on the first fastening section extending essentially circularly in the positioning plane.

22. The air spring fastening of claim 17, wherein the second engagement section comprises a cavity that is engaged by at least one of the second engagement section and an engagement arrangement.

23. The air spring fastening of claim 17, wherein the positioning element may be fixed to the first fastening section in a rotated installation position both in the positioning plane and transverse to the positioning plane.

24. The air spring fastening of claim 9, wherein the second engagement section comprises a threaded pin that is integral with the positioning element.

25. The air spring fastening of claim 24, wherein the first fastening section comprises a cavity transverse to the positioning plane on the air spring unit, and wherein the second fastening section is located on the radius arm unit.

26. The air spring fastening of claim 25, wherein the first fastening section comprises a retention collar against which the positioning element may be urged via the fastening arrangement frictionally fix the air spring unit to the radius arm unit.

27. The air spring fastening of claim 13, wherein the positioning element comprises a plurality of second engagement sections, and wherein the distances (a) of at least some of the plurality of second the engagement sections differ from each other.

28. The air spring fastening of claim 27, wherein a pair of adjacent second engagement sections of the plurality of second engagement sections are arranged displaced by an angle (α) relative to one another, and wherein the angle (α) is greater than 0° and less than 180°.

29. The air spring fastening of claim 28, wherein an absolute value of a deviation of a respective angle α₁ . . . αₙ from a value of the relationship of 360° to a number of second engagement sections is between about 0° and about 90.

30. The air spring fastening of claim 29, wherein the absolute value of the deviation of the respective angle α₁ . . . αₙ from the value of the relationship of 360° to the number of second engagement sections is between 0° and 30°.

31. The air spring fastening of claim 30, wherein the absolute value of the deviation of the respective angle α₁ . . . aₙ from the value of the relationship of 360° to the number of second engagement sections is between 0° and 10°.

32. The air spring fastening of claim 13, wherein the first engagement section has a polygonal extension in the positioning plane, and wherein the first fastening section has a polygonal extension in the positioning plane, which corresponds to the polygonal extension of the first engagement section at least over a certain area.

33. The air spring fastening of claim 13, wherein the first engagement section extends essentially circularly in the positioning plane and comprises at least one projection along the positioning plane engageable with a corresponding recess on the first fastening section extending essentially circularly in the positioning plane.

34. The air spring fastening of claim 13, wherein the second engagement section comprises a cavity that is engaged by at least one of the second engagement section and an engagement arrangement.

35. The air spring fastening of claim 13, wherein the positioning element may be fixed to the first fastening section in a rotated installation position both in the positioning plane and transverse to the positioning plane.

36. The air spring fastening of claim 13, wherein the second engagement section comprises a threaded pin that is integral with the positioning element.

37. The air spring fastening of claim 13, wherein the first fastening section comprises a cavity transverse to the positioning plane on the air spring unit, and wherein the second fastening section is located on the radius arm unit.

38. The air spring fastening of claim 13, wherein the first fastening section comprises a retention collar against which the positioning element may be urged via the fastening arrangement frictionally fix the air spring unit to the radius arm unit.
